(19) United States
(12) Patent Application Publication
(10) Pub. No.: US 2019/0171826 A1
(43) Pub. Date: Jun. 6, 2019

(54) APPARATUS AND METHOD FOR BLOCKING RANSOME WARE USING ACCESS CONTROL TO THE CONTENTS FILE

(71) Applicant: WITHNETWORKS CO., LTD., Seoul (KR)

(72) Inventor: Byung Gon LEE, Suwon-si, Gyeonggi-do (KR)

(21) Appl. No.: 16/327,510

(22) PCT Filed: Aug. 30, 2017
(86) PCT No.: PCT/KR2017/009512

§ 371 Date: Feb. 22, 2019

(30) Foreign Application Priority Data
Sep. 22, 2016 (KR) 10-2016-0121605

(51) Int. Cl. G06F 21/60; G06F 21/56; G06F 21/62

(52) U.S. Cl. CPC G06F 21/604; G06F 2221/2139; G06F 21/6281; G06F 21/56

(57) ABSTRACT

The present application relates to the apparatus for blocking Ransome ware using access control to the contents file, it includes an access permission program checking unit for checking whether a program of a process detected as being started in an user's computer is a reliable program, checking whether a parent process of the program is a reliable program, and determining whether the program is the program that is allowed to access the contents file; a whitelist registration unit for registering information of the contents file to be protected; and a contents file access control unit for allowing the process to access the contents file registered in the whitelist registration unit when the program of the process is the program that is allowed to access the contents file determined by the access permission program checking unit, and blocking the process from accessing the contents file registered in the whitelist registration unit when the program of the process is not the program that is allowed to access the contents file determined by the access permission program checking unit.

### BACKGROUND OF THE INVENTION

### Field of the Invention

The present application relates to apparatus and method for blocking Ransome ware using access control to the contents file.

### Description of the Related Art

Ransome ware is a type of malware and it is illegally installed on a user's computer without the user's consent, encrypting the user's files and making them unusable, and it is a malicious program that makes a monetary request in exchange for a password to decrypt it.

Ransome ware is becoming a major source of revenue for attackers, and the distribution method and file formats are becoming more diverse, and the damage from Ransome ware attacks is getting more serious. Therefore, it is necessary to develop a defense technology.

In order to solve these problems, the variety of detection devices and methods are used to defense Ransome ware such as Signature based detection, Behavior based detection, decoy based detection, and file backup based defense, etc.

These technologies used by existing security solutions are technologies for detecting malicious programs such as viruses and Trojan horses and cannot prevent the encryption itself.

### SUMMARY OF THE INVENTION

The embodiment intends to detect and block unauthorized encryption of a user's contents file by an apparatus and method for blocking Ransome ware.

The embodiment also provides an apparatus and method for controlling a random access to the contents file by the program without modification authority to the contents file by broadening the scope without detecting and blocking only Ransome ware.

According to the embodiment, the apparatus for blocking Ransome ware using the contents file access control includes an access permission program checking unit for checking whether a program of a process detected as being started in an user's computer is a reliable program, checking whether a parent process of the program is a reliable program, and determining whether the program is the program that is allowed to access the contents file; a whitelist registration unit for registering information of the contents file to be protected; and a contents file access control unit for allowing the process to access the contents file registered in the whitelist registration unit when the program of the process is the program that is allowed to access the contents file determined by the access permission program checking unit, and blocking the process from accessing the contents file registered in the whitelist registration unit when the program of the process is not the program that is allowed to access the contents file determined by the access permission program checking unit.

The access permission program checking unit includes a process start detecting unit, a reliable program checking unit, a process tree tracking unit, and a contents file access permission information storing unit.

The process start detecting unit detects that a process is started in the user's computer.

The reliable program checking unit determines whether the program of the process detected by the process start detecting unit is the reliable program.

The reliable program is any one of programs that the user has installed on the user's computer or programs preinstalled on the user's computer.

The process tree tracking unit obtains parent process path information for the program of the process.

The contents file access permission information storing unit obtains parent process path information for the program when the program of the process is the reliable program, determines whether the program of the patent process is Explorer.exe or Services.exe when the program of the parent process is the reliable program, and stores the program of the process as the program that is allowed to access the contents file when the program of the patent process is Explorer.exe or Services.exe.

The contents file access permission information storing unit obtains parent process path information for the program when the program of the process is the reliable program, repeats the step of determining whether the program of the parent process is Explorer.exe or Services.exe when the program of the parent process is the reliable program, and stores the program of the process as the program that is allowed to access the contents file when the final program of the parent process is Explorer.exe or Services.exe.

The contents file access control unit includes a file access detecting unit, a whitelist checking unit, a contents file access permission information checking unit, and a process blocking unit.

The file access detecting unit detects that the process attempts to access and modify the contents file.

The whitelist checking unit checks whether the contents file that the process attempts to modify is the file registered in the whitelist registration unit.

The contents file access permission information checking unit checks whether the program of the process is the program that is allowed to access the contents file stored in the contents file access permission information storing unit.

The process blocking unit blocks the process from accessing the contents file registered in the whitelist registration unit when the program of the process is the program whose access to the contents file is not allowed.

A method for blocking Ransome ware to a contents file using access control to the contents file comprises; determining whether the program of the process detected as being started in the user's computer is a program that is allowed to access the contents file; and blocking the access of the process to the contents file registered in a whitelist registration unit registering the contents file information to be protected if the program of the process is not the program that is allowed to access the contents file, wherein the step of determining whether the program of the process is the program that is allowed to access the contents file includes; determining whether the process of the program is a reliable program; checking parent process information comprising tracing the process tree to obtain parent process information for the program of the process if the program of the process is the reliable program, determining whether the obtained program of the parent process is the reliable program, and determining whether the program of the parent process is Explorer.exe or Services.exe when the program of the parent process is the reliable program; and storing the program of the process as the contents file access permission program when the program of the parent process is Explorer.exe or Services.exe.

The step of determining whether the program is the reliable program determines whether the program is any one of programs that the user has installed on the user's computer or programs preinstalled on the user's computer.

The step of checking parent process information comprises the steps of tracing the process tree to obtain parent process information for the program of the process if the program of the process is the reliable program, determining whether the acquired program of the parent process is the reliable program, repeating the step of determining whether the program of the parent process is Explorer.exe or Services.exe when the program of the parent process is reliable, and determining the final program of the parent process is Explorer.exe or Services.exe.

The step of blocking the process from accessing the contents file registered in the whitelist registration unit when the program of the process is not the program that is allowed to access the contents file includes; detecting that the process attempts to access the contents file and modify the contents file; checking whether the contents file is the contents file registered in the whitelist registration unit; checking whether the program of the process is the program that is allowed to access the contents file if the contents file is determined to be the contents file registered in the whitelist registration unit; and blocking the process from accessing the contents file if the program of the process is not the program that is allowed to access the contents file.

The step of detecting that the process attempts to access the contents file and modify the contents file registers a mini-filter in an operating system of the user's computer to detect attempts to modify the file.

According to the present application, it is possible to provide an apparatus and method for detecting and blocking unauthorized encryption of the user file, and provide apparatus and method for controlling the program when the program without a modification authority to the contents file accesses the contents file at random.

### BRIEF DESCRIPTION OF THE DRAWINGS

Hereinafter, embodiments of the present application will be described in detail with reference to the accompanying drawings. The drawings described below are all embodiments of the present application, and those skilled in the art will be able to obtain other drawings on the basis of these drawings without further efforts to create the inventive step.

FIG. 1 is a detailed block diagram of Ransome ware blocking apparatus using a contents file access control according to an embodiment of the present application.

FIG. 2A is an exemplary diagram showing the program the user has installed on the user's computer on a window, and FIG. 2B is an exemplary diagram showing the program preinstalled on the user's computer.

FIG. 3 is a diagram illustrating a process of obtaining a parent process path using a process tree.

FIG. 4 is a flowchart illustrating a method for determining (S100) whether a program used in a user's computer according to the present application is a program that is allowed to access a contents file.

FIG. 5 is a flowchart illustrating a method (S200) for allowing a program used in a user's computer to access a contents file according to the present application.

### DETAILED DESCRIPTION OF THE INVENTION

The advantages and features of the present application and the manner of achieving them will become apparent with reference to the embodiments described in detail below with reference to the accompanying drawings. The present application may, however, be embodied in many different forms and should not be construed as limited to the embodiments set forth herein. Rather, these embodiments are provided so that the disclosure of the present application is complete and that those skilled in the art will fully understand the scope of the present application, and the present application is only defined by the scope of the claims.

In the following description of the present application, a detailed description of known functions and configurations incorporated herein will be omitted when it may make the subject matter of the present application rather unclear. The following terms are defined in consideration of the functions in the embodiments of the present application, which may vary depending on the intention of the user, the intention or the custom of the operator. Therefore, the definition should be based on the contents throughout this specification.

First, a contents file, which is a technical term used in the present application, is defined. A contents file is a file storing information necessary for a user on a user's computer, for example, .xls, .doc, .pdf, .jpg, .avi, .rar, .zip, .mp4, .png, .psd, .hwp, .java, js, and so on. The contents file may be stored in a local storage space built in a user's computer or may be stored in an external memory card that is detachable to the user's computer. The external memory card may be a Secure Digital (SD) card, a MultiMedia Card (MMC), a Compact Flash (CF) card, a Micro Drive, a Memory Stick, a Smart Media card, or an Extreme Digital (xD) picture card. It may also be stored in a Universal Serial Bus (USB) memory or a solid state drive (SSD). Further, it may be a file stored in an external storage space using a cloud service formed outside the user's computer.

Since the contents file stores information necessary for the user, it is necessary to block access to the contents file by Ransome ware.

Hereinafter, the apparatus and the method for blocking Ransome ware of the present application will be described.

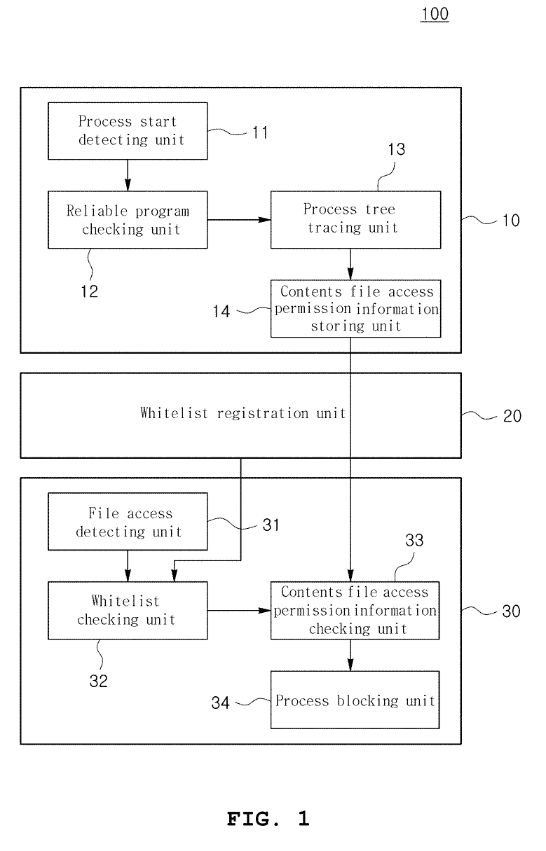

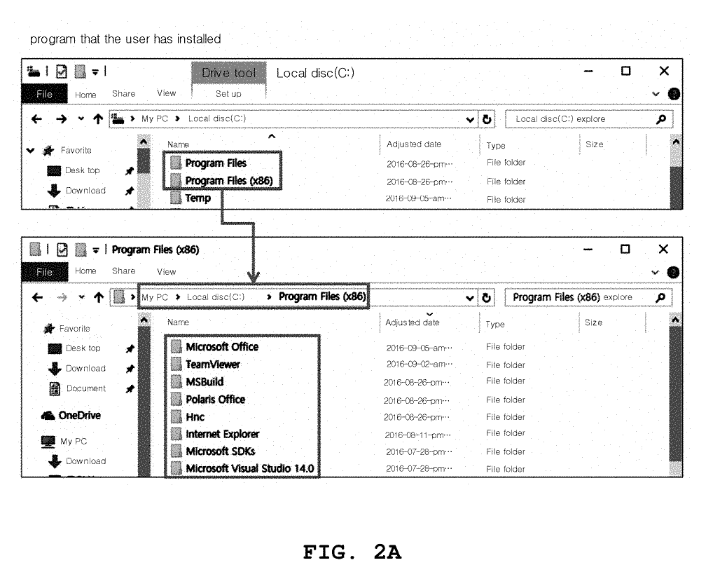

FIG. 1 is a detailed block diagram of Ransome ware blocking apparatus using the contents file access control according to the embodiment of the present application.

Referring to FIG. 1, apparatus for blocking Ransome ware 100 using access control to the contents file according to an embodiment of the present application is an apparatus for blocking Ransome ware when Ransome ware accesses and modifies the contents file in the user's computer, includes an access permission program checking unit 10, a whitelist registration unit 20, and a contents file access control unit 30. The apparatus for blocking Ransome ware 100 using access control to contents file may further include an interface unit or a predetermined network communication unit for connection with other devices.

The user's computer may include a desktop computer, a smart phone, a tablet computer, and the like. In addition, the user's computer may execute various programs based on an operating system (OS), and the operating system may include all operating systems of Microsoft Corporation including Windows XP, Windows 7, Windows 8, Windows 10, etc.

First, the access permission program checking unit 10 determines whether the program used in the user's computer is the program is allowed to access the contents file and classifies the program. The access permission program checking unit 10 includes a process start detecting unit 11, a reliable program checking unit 12, a process tree tracking unit 13, and a contents file access permission information storing unit 14 for such determination and classification.

The process start detecting unit 11 detects that a specific process is started in the user's computer. The process is that the program is executed in the user's computer.

The reliable program checking unit 12 determines whether the program of the process detected by the process start detecting unit 11 is the reliable program. Here, the reliable program is either the program the user has installed on the user's computer or the program preinstalled on the user's computer.

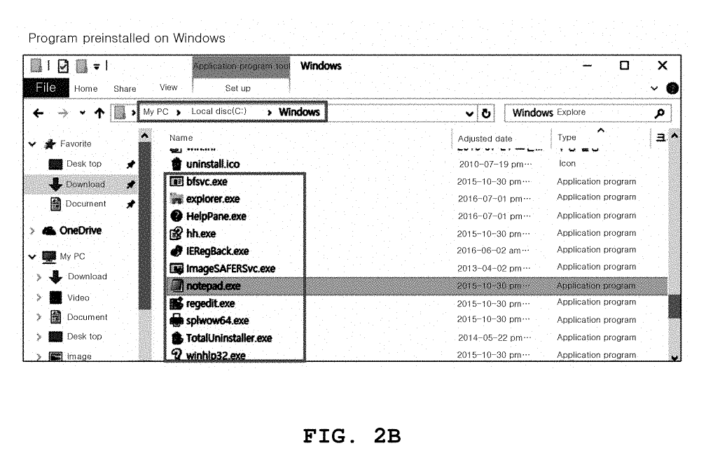

FIG. 2A is an exemplary diagram showing the program the user has installed on the user's computer on a window, and FIG. 2B is an exemplary diagram showing the program preinstalled on the user's computer.

Referring to FIG. 2A, a program installed on the user's computer by the user is disclosed in sub-list of a Windows//Program Files.

Referring to FIG. 2B, various programs such as bfsvc.exe, explorer.exe, HelpPane.exe, hh.exe, IERegBack.exe, ImageSAFERSvc.exe, and notepad.exe, etc. are disclosed under the Windows as programs that are preinstalled on the user's computer.

The process tree tracking unit 13 obtains parent process path information for the program when the program of the process is the reliable program. The parent process path information can be defined to track through the process tree.

The process tree tracking unit 13 then determines whether the parent process is finally Explorer.exe or Services.exe when the parent process is the reliable program.

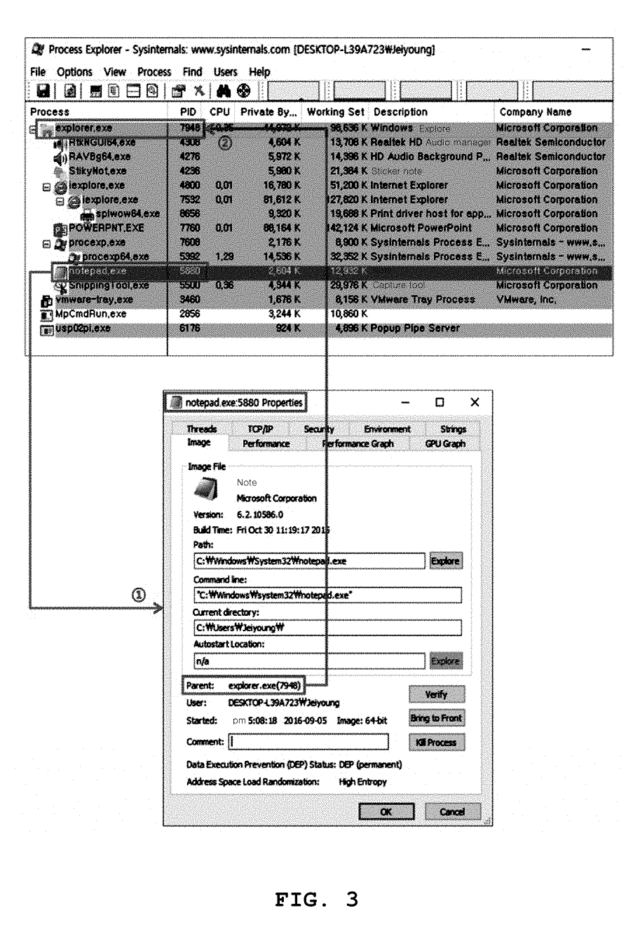

FIG. 3 is a diagram illustrating a process of obtaining a parent process path using a process tree.

Referring to FIG. 3, when the program of the process is notepad.exe, the process ID and parent process ID of notepad.exe are obtained (\textcircled{1}), and the parent process ID is traced to confirm the parent process (\textcircled{2}). In the embodiment of FIG. 3, explorer.exe is a program of the parent process.

The contents file access permission information storing unit 14 stores the program of the process as the program that is allowed to access the contents file when the program of the parent process is finally Explorer.exe or Services.exe. In the case where the program of the process is not reliable and the parent process of the program of the process is not reliable even when the program of the process is the reliable program, the contents file access permission information storing unit 14 stores the program of the process as a program that is not allowed to access the contents file.

In the embodiment of FIG. 3, since the program of the parent process is finally Explorer.exe, the notepad.exe is stored as the program that is allowed to access the contents file.

The whitelist registration unit 20 registers the contents file information to be protected as the whitelist.

The whitelist registration unit 20 may register the extension of the contents file or may register an individual file.

The contents file access control unit 30 allows access to the contents file if the program of the process is the program that is allowed to access the contents file, and if the program of the process is not the program that is allowed to access the contents file, the contents file access control unit 30 blocks the process from accessing and modifying the contents file. The contents file access control unit 30 includes a file access detecting unit 31, a whitelist checking unit 32, a contents file access permission information checking unit 33, and a process blocking unit 34.

The file access detecting unit 31 detects that the process attempts to access the contents file and attempt to modify the contents file. Specifically, the file access detecting unit 31 can detect the file modification attempt by registering a mini-filter in the operating system. The whitelist checking unit 32 checks whether the contents file that the process attempts to modify is a file registered in the whitelist registration unit 20.

At this time, if the contents file to be modified by the process is a file not registered in the whitelist registration unit 20, the process may be allowed to access the contents file stored in the user's computer to modify the contents file.

If the contents file that the process attempts to modify is the contents file registered in the whitelist registration unit 20, the contents file access permission information checking unit 33 determines whether the program of the process is the program that is allowed to access the contents file stored in the contents file access permission information storing unit 14.

If the program of the process is not the program that is allowed to access the contents file, the process blocking unit 34 blocks the process from accessing the contents file and ends the process, and if the program of the process is the program that is allowed to access the contents file, the process blocking unit 34 allows the process to access the contents file.

Although the apparatus blocking Ransome ware 100 by using access control to the contents file according to an embodiment of the present application is divided into detailed blocks, the apparatus blocking Ransome ware 100 may be integrated into one or various types.

If the process that does not have the authority to modify the contents file and that access the contents file at random is blocked by this apparatus, it is possible to block Ransome ware, thereby reducing the damage caused by Ransome ware.

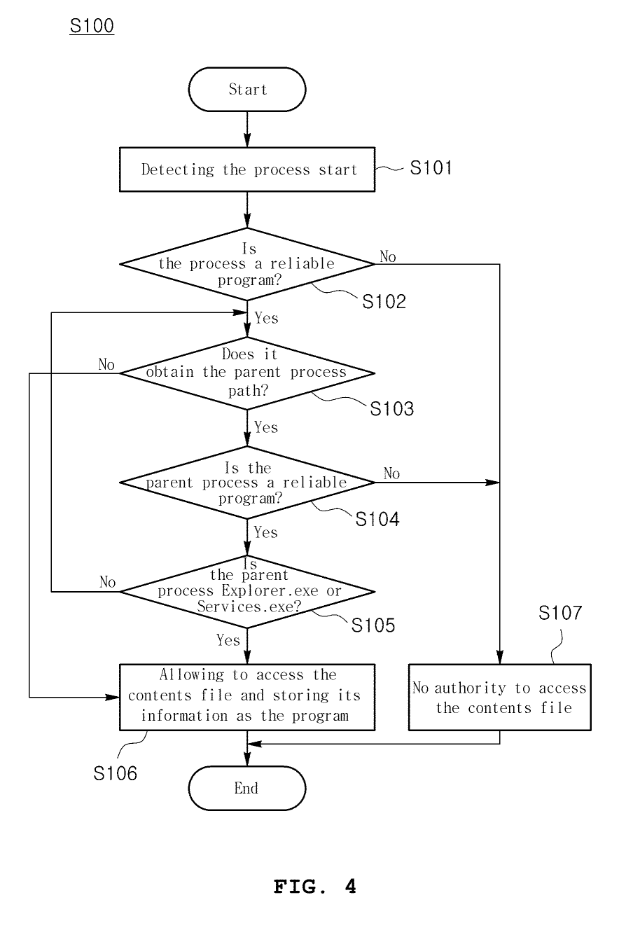

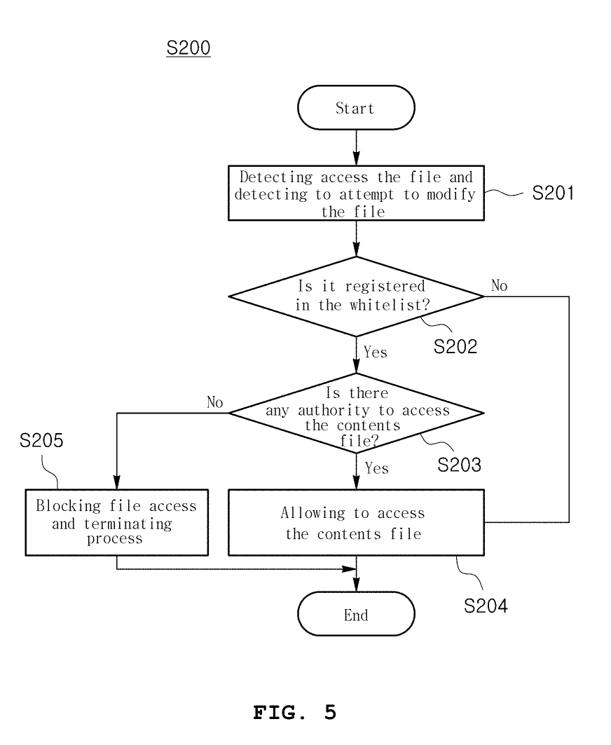

Hereinafter, method for blocking Ransome ware by using access control to contents file according to the present application will be described with reference to FIG. 4 and FIG. 5.

First, the method for determining whether the program used in the user's computer is the program that is allowed to access a contents file will be described.

FIG. 4 is a flowchart illustrating a method for determining (process S100) whether a program used in a user's computer is a program that is allowed to access a contents file according to the present application.

Referring to FIG. 4, first, process S101 is detecting that the process is started in the user's computer.

Then, process S102 is determining whether the program of the detected process is the reliable program. Here, the reliable program is either a program installed on the user's computer by user or a program preinstalled on the user's computer.

If the program of the detected process is the reliable program, process S103 is tracing the process tree to obtain parent process information for the program of the process.

Then, process S104 is determining whether the acquired program of the parent process is the reliable program.

If the program of the parent process is the reliable program, process S105 is determining whether the program of the parent process is Explorer.exe or Services.exe.

If the program of the parent process is Explorer.exe or Services.exe, process S106 is storing the program of the process as the program to be allowed to access the contents file.

If the program of the parent process is not Explorer.exe or Services.exe, process S103 is obtaining the parent's parent process information for the program of the parent process again. Thereafter, process S104 is determining whether the program of the parent's parent process is the reliable program. This process is repeated until the parent process of the parent process is Explorer.exe or Services.exe.

Therefore, when the program of the parent process is finally Explorer.exe or Services.exe, process S106 is storing the program of the process as the program to be allowed to access the contents file.

If the program of the detected process is unreliable, process S107 is determining that there is no access authority to the contents file. In addition, even if the parent process is a program that is not reliable, process S107 is determining that there is no access authority to the contents file.

Through these steps, it can be determined whether the program used in the user's computer is a program that is allowed to access the contents file.

FIG. 5 is a flowchart illustrating a method for allowing (S200) a program used in a user's computer to access a contents file according to the present application.

Referring to FIG. 5, process S201 is detecting that a specific process accesses a contents file and attempts to modify the contents file. Specifically, it is possible to detect a file modification attempt by registering a mini-filter in the operating system.

Then, process S202 is determining whether the contents file to be modified by the process is the contents file stored in the whitelist registration unit.

At this time, if the contents file that the process attempts to modify is a contents file not registered in the whitelist registration unit, process S204 may allow the process to access the contents file stored in the user's computer and modification of the contents file.

If the file that the process attempts to modify is determined to be the contents file registered in the whitelist registration unit, process S203 is checking whether the program of the process is a contents file access permission program determined by the process S100 of determining whether the program of the process is allowed to access the contents file.

At this time, if the program of the process is the program that is allowed to access the contents file, process S204 is allowing the process to access the contents file. If the program of the process is not the program that is allowed to access the contents file, process S205 is blocking the process to access the contents file, and terminating the process.

Through these steps, a program used in the user's computer can be allowed to access the contents file or blocked from accessing the contents file.

Thus, when the process starts, information of the program to access a contents file and its parent process information are tracked and grasped to allow and block access to the contents file of the process, thereby preventing the contents file from being damaged by Ransome ware. In addition, it is possible to control the random access to the contents file of the program which does not have an authority to modify the contents file by broadening the scope without detecting and blocking only Ransome ware.

Using such the contents file access control technology, it is possible to distinguish whether the user directly opens a document file to modify it, or an illegal program opens the file to modify it. Therefore, regardless of how Ransome ware works, regardless of Ransome ware's inflow path or form, when Ransome ware has access to the user's contents file without the modification authority, Ransome ware can be immediately blocked, and the security of the user's computer can be dramatically increased.

The foregoing is merely a preferred embodiment of the present application and is not intended to limit the present application. All such modifications, equivalents, and improvements that come within the spirit and scope of the principles of this application are intended to be included within the scope of the present application.
100: Apparatus for blocking Ransome ware by using access control to contents file
10: Access permission program checking unit
20: Whitelist registration unit
30: Contents file access control unit
11: Process start detecting unit
12: Reliable program checking unit
13: Process tree tracing unit
14: Contents file access permission information storing unit
31: File access detecting unit
32: Whitelist checking unit
33: Contents file access permission information checking unit
34: Process blocking unit

What is claimed is:

1. An apparatus for blocking Ransome ware using access control to contents file comprising:
an access permission program checking unit for checking whether a program of a process detected as being started in an user's computer is a reliable program, checking whether a parent process of the program is the reliable program, and determining whether the program is the program that is allowed to access the contents file;
a whitelist registration unit for registering information of the contents file to be protected; and
a contents file access control unit for allowing the process to access the contents file registered in the whitelist registration unit when the program of the process is the program that is allowed to access the contents file determined by the access permission program checking unit, and blocking the process from accessing the contents file registered in the whitelist registration unit when the program of the process is not the program that is allowed to access the contents file determined by the access permission program checking unit.

2. The apparatus for blocking Ransome ware using access control to contents file of claim 1, wherein the access permission program checking unit includes a process start detecting unit, a reliable program checking unit, a process tree tracking unit, and a contents file access permission information storing unit.

3. The apparatus for blocking Ransome ware using access control to contents file of claim 2, wherein the process start detecting unit detects that the process is started in the user's computer.

4. The apparatus for blocking Ransome ware using access control to contents file of claim 2, wherein the reliable program checking unit determines whether the program of the process detected by the process start detecting unit is the reliable program.

5. The apparatus for blocking Ransome ware using access control to contents file of claim 4, wherein the reliable program is any one of programs that the user has installed on the user's computer or programs preinstalled on the user's computer.

6. The apparatus for blocking Ransome ware using access control to contents file of claim 2, wherein the process tree tracking unit obtains parent process path information for the program of the process.

7. The apparatus for blocking Ransome ware using access control to contents file of claim 6, wherein the contents file access permission information storing unit obtains parent process path information for the program when the program of the process is the reliable program, determines whether the program of the patent process is Explorer.exe or Services.exe when the program of the parent process is the reliable program, and stores the program of the process as the program that is allowed to access the contents file when the program of the patent process is Explorer.exe or Services.exe.

8. The apparatus for blocking Ransome ware using access control to contents file of claim 7, wherein the contents file access permission information storing unit obtains parent process path information for the program when the program of the process is the reliable program, repeats the step of determining whether the program of the parent process is Explorer.exe or Services.exe when the program of the parent process is the reliable program, and stores the program of the process as the program that is allowed to access the contents file when the final program of the parent process is Explorer.exe or Services.exe.

9. The apparatus for blocking Ransome ware using access control to contents file of claim 2, wherein the contents file access control unit includes a file access detecting unit, a whitelist checking unit, a contents file access permission information checking unit, and a process blocking unit.

10. The apparatus for blocking Ransome ware using access control to contents file of claim 9, wherein the file access detecting unit detects that the process attempts to access and modify the contents file.

11. The apparatus for blocking Ransome ware using access control to contents file of claim 10, wherein the whitelist checking unit checks whether the contents file that the process attempts to modify is the file registered in the whitelist registration unit.

12. The apparatus for blocking Ransome ware using access control to contents file of claim 9, wherein the contents file access permission information checking unit checks whether the program of the process is the program that is allowed to access the contents file stored in the contents file access permission information storing unit.

13. The apparatus for blocking Ransome ware using access control to contents file of claim 9, wherein the process blocking unit blocks the process from accessing the contents file registered in the whitelist registration unit when the program of the process is the program whose access to the contents file is not allowed.

14. A method for blocking Ransome ware to a contents file using access control to the contents files comprising;
determining whether a program of the process detected as being started in the user's computer is a program that is allowed to access the contents file; and
blocking the access of the process to the contents file registered in a whitelist registration unit registering the contents file information to be protected if the program of the process is not the program that is allowed to access the contents file,
wherein the step of determining whether the program of the process is the program that is allowed to access the contents file includes;
determining whether the process of the program is a reliable program;
checking parent process information comprising tracing the process tree to obtain parent process information for the program of the process if the program of the process is the reliable program, determining whether the obtained program of the parent process is the reliable program, and determining whether the program of the parent process is Explorer.exe or Services.exe when the program of the parent process is the reliable program; and
storing the program of the process as the contents file access permission program when the program of the parent process is Explorer.exe or Services.exe.

15. The method for blocking Ransome ware to a contents file using access control to the contents file of claim 14, wherein the step of determining whether the process of the program is a reliable program determines whether the program is any one of programs that the user has installed on the user's computer or programs preinstalled on the user's computer.

16. The method for blocking Ransome ware to a contents file using access control to the contents file of claim 14, wherein the step of checking parent process information comprises the steps of tracing the process tree to obtain parent process information for the program of the process if the program of the process is the reliable program, determining whether the acquired program of the parent process is the reliable program, repeating the step of determining whether the program of the parent process is Explorer.exe or Services.exe when the program of the parent process is reliable, and determining the final program of the parent process is Explorer.exe or Services.exe.

17. The method for blocking Ransome ware to a contents file using access control to the contents file of claim 14, wherein the step of blocking the access of the process to the contents file registered in a whitelist registration unit if the program of the process is not the program that is allowed to access the contents file includes;
detecting that the process attempts to access the contents file and modify the contents file;
checking whether the contents file is the contents file registered in the whitelist registration unit;
checking whether the program of the process is the program that is allowed to access the contents file if the contents file is determined to be the contents file registered in the whitelist registration unit, and
blocking the process from accessing the contents file if the program of the process is not the program that is allowed to access the contents file.

18. The method for blocking Ransome ware to a contents file using access control to the contents file of claim 17, wherein the step of detecting that the process attempts to access the contents file and modify the contents file registers a mini-filter in an operating system of the user's computer to detect attempts to modify the file.
